(19) United States
(12) Patent Application Publication
(10) Pub. No.: US 2018/0120560 A1
(43) Pub. Date: May 3, 2018

(54) PROJECTOR AND FOCAL LENGTH ADJUSTING METHOD

(71) Applicant: Coretronic Corporation, Hsin-Chu (TW)

(72) Inventors: CHUN-CHIEH WANG, Hsin-Chu (TW); ZHI-XIANG LI, Hsin-Chu (TW); JUI-TA LIU, Hsin-Chu (TW); YU-CHI WU, Hsin-Chu (TW)

(21) Appl. No.: 15/793,769

(22) Filed: Oct. 25, 2017

(30) Foreign Application Priority Data
Oct. 28, 2016 (CN) 201610965701.8

(51) Int. Cl. G02B 27/00; G03B 21/14; G02B 27/40; H04N 5/232; G02B 7/09

(52) U.S. Cl. CPC G02B 27/0075; G03B 21/142; G02B 7/09; H04N 5/23212; G02B 27/40

(57) ABSTRACT

A projector includes a projection lens, an image capture module and a processor. The projection lens projects a projection image onto a display surface. The image capture module is disposed on one side of the projection lens and captures an image frame covering the projection image and defines a plurality of zones on the image frame. The zones correspond to parts of the image frame and cover at least the projection image and do not cover the entire image frame. The image capture module analyzes the parts of the image frame to obtain image data including a plurality of respective zone values. The processor is electrically connected to the image capture module and receives the image data and adjusts a focal length of the projection lens according to at least two of these zone values selected based on the image data. A focal length adjusting method is also provided.

### CROSS-REFERENCE TO RELATED APPLICATION

THIS APPLICATION CLAIMS THE PRIORITY BENEFIT OF CN201610965701.8 FILED ON 2016, Oct. 28. THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a projector, and more particularly to a projector capable of automatically adjusting a focal length.

### BACKGROUND OF THE INVENTION

Projector is a display device for generating a large-size image on the screen. The imaging principle of the projector is to convert the illumination beam generated by the light source into the image beam through the light valve and then project the image beam to the projection surface (for example, a projection screen or a wall) through the lens, thereby displaying the image. With the progress of projection technology and the reduction of manufacturing cost, the use of the projector has been gradually extended from commercial use to home use, and the mini projector with compact size has gradually become the mainstream in market.

When a general projector is in use, the size of the projection screen and the distance from the projection screen to the optical projector are limited by the space used in the environment. Therefore, in general, the projection lens of the projector usually is equipped with auto-focus function to allow users to easily adjust the size or resolution of the picture projected by the lens.

The common auto-focus technologies are infrared autofocus, ultrasound autofocus and camera autofocus. The principle of infrared autofocus is based on that the projector actively emits infrared signal to the projection surface of the projector and performs the focal according to the infrared light reflected by the projection surface and received by a receiver. The principle of ultrasound autofocus is based on that the ultrasonic vibration generator continuously emits ultrasound, a receiver of the projector receives the returned sound signal after the ultrasound reaches the projection surface, and the projector performs the focal length adjustment according to the distance calculated based on the round-trip time of the ultrasound. The principle of camera autofocus is based on that the camera captures the projected image, processes the captured image data to operate, and performs the focal according to the operation result.

However, the infrared autofocus method has some disadvantages such as that the infrared signal is susceptible to external ambient light, which may lead to misalignment of the focus. The ultrasound autofocus method has some disadvantages such as that the projector may not accurately calculate the distance between the projector and the projection surface when an obstacle exits between the projector and the projection surface. The camera autofocus method has some disadvantages such as that the camera has to capture the entire projection picture or sampling the edge for comparison, and accordingly it is time consuming and system resource consuming if the data of the captured projection picture is huge. Therefore, how to improve the above-mentioned problem is the focus of attention of the person in the art of the field.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

Therefore, one objective of the invention is to provide a projector capable of adjusting a focal length automatically and effectively.

Another objective of the invention is to provide a focal length adjusting method for a projector, so that the projector is capable of adjusting a focal length automatically and effectively.

Other objectives and advantages of the invention can be further illustrated by the technical features broadly embodied and described as follows.

In order to achieve one or a portion of or all of the objects or other objects, the invention provides a projector, which includes a projection lens, an image capture module and a processor. The projection lens is adapted to project a projection image onto a display surface. The image capture module is disposed on one side of the projection lens and adapted to capture an image frame covering the projection image and define a plurality of zones on the image frame. The plurality of zones respectively correspond to different parts of the image frame. The plurality of zones cover at least the projection image and do not cover the entire image frame. The image capture module further analyzes the parts of the image frame respectively corresponding to the plurality of zones to obtain image data. The image data includes a plurality of zone values respectively corresponding to the plurality of zones. The processor is electrically connected to the image capture module. The processor receives the image data and adjusts a focal length of the projection lens according to at least two of the plurality of zone values selected based on the image data.

The invention further provides a focal length adjusting method for a projector. The projector includes a projection lens, an image capturing module and a processor. The focal length adjusting method includes: configuring the projector to project a projection image onto a display surface through a projection lens; configuring the image capture module to capture an image frame covering the projection image and define a plurality of zones on the image frame, wherein the plurality of zones respectively correspond to different parts of the image frame, and the plurality of zones cover at least the projection image and do not cover the entire image frame; configuring the image capture module to analyze the parts of the image frame respectively corresponding to the plurality of zones to obtain image data, wherein the image data comprises a plurality of zone values respectively corresponding to the plurality of zones; configuring the processor to receive the image data and adjust a focal length of the projection lens according to at least two of the plurality of zone values selected based on the image data.

In summary, the projector and the focal length adjusting method in accordance with the embodiments of the invention define a plurality of zones respectively corresponding to different parts of the image frame which covers the entire projection image and is captured by the image capture module, obtain the image data including a plurality of zone values respectively corresponding to the zones, and adjust the focal length of the projection lens according to at least two of these zone values selected based on the image data by the processor. Therefore, compared with the known technique in that the focal length adjustment is performed based on the data obtained by analyzing the entire image frame, the projector and the focal length adjusting method in accordance with the embodiments of the invention can perform the focal length adjustment more quickly and efficiently.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a structure and operation of a projector in accordance with an embodiment of the invention;

FIG. 2 is a functional block diagram of the projector shown in FIG. 1;

FIG. 3 is a diagram showing the content of a lookup table of the projector of the embodiment;

FIG. 4 is a schematic view of a structure and operation of a projector in accordance with another embodiment of the invention; and

FIG. 5 is a flow chart of a focal length adjusting method in accordance with an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

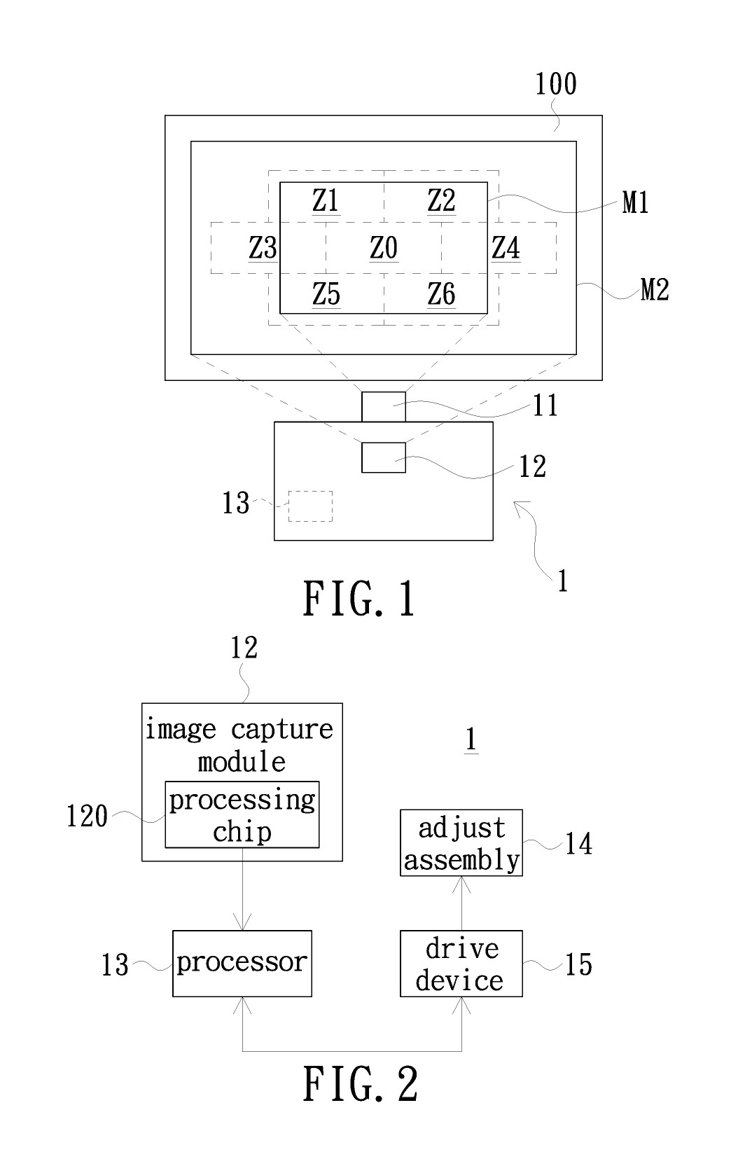

Please refer to FIG. 1, which is a schematic view of a structure and operation of a projector in accordance with an embodiment of the invention. The projector 1 of the embodiment includes a projection lens 11, an image capture module 12 and a processor 13. The projection lens 11 is adapted to project a projection image M1 onto a display surface 100. In the embodiment, the display surface 100 is, for example, a projection screen, but the invention is not limited thereto. The image capture module 12 is disposed on one side of the projection lens 11. In the embodiment, the image capture module 12 is disposed, for example, above the projection lens 11, but the invention is not limited thereto. The image capturing module 12 is, for example, an independent module disposed inside or outside the projector 1. The image capture module 12 is an optical sensor such as a camera, a complementary metal-oxide-semiconductor (CMOS), a charge-coupled device (CCD), a color sensor, an infrared (IR) sensor or the like, but the invention is not limited thereto. Any suitable visible light sensor or invisible light sensor may be used as the image capture module 12 of the invention. The image capture module 12 is adapted to capture an image frame M2 covering the entire projection image M1. The processor 13 is electrically connected to the image capture module 12 and is adapted to process image data transmitted from the image capture module 12. The processor 13 may be a central processing unit (CPU), a microprocessor, a controller, a micro control unit (microcontroller unit, MCU), a digital signal processor (DSP), a programmable controller, an application specific integrated circuit (ASIC), a programmable logic device (PLD), a complex programmable logic device (CPLD) or a network computer, but the invention is not limited thereto.

Please refer to FIG. 1 continuously. The image capture module 12 of the embodiment defines a plurality of zones on each image frame M2. In the embodiment, the number of the zones defined by the image capture module 12 on the image frame M2 is, for example, seven, which are zones Z0, Z1, Z2, Z3, Z4, Z5 and Z6. The invention does not limit the number of these zones, but the number of zones is not less than two. These zones Z0, Z1, Z2, Z3, Z4, Z5 and Z6 correspond to different parts of the image frame M2 respectively, and these zones Z0, Z1, Z2, Z3, Z4, Z5 and Z6 cover at least part of or the entire projection image M1 and do not cover the entire image frame M2. The image capture module 12 further analyzes the part of the image frame M2 corresponding to the zones Z0, Z1, Z2, Z3, Z4, Z5 and Z6 to obtain image data, and the image data includes a plurality of zone values corresponding to the respective zones Z0, Z1, Z2, Z3, Z4, Z5 and Z6. The processor 13 receives the image data transmitted from the image capture module 12 and adjusts the focal length of the projection lens 11 according to at least two of these zone values selected based on the image data. In the embodiment, among these zones Z0, Z1, Z2, Z3, Z4, Z5 and Z6 defined by the image capture module 12 on each image frame M2, the zone Z0 is, for example, located at the center of the projection image M1, and the other zones Z1, Z2, Z3, Z4, Z5 and Z6 surround the zone Z0. The areas of these zones Z0, Z1, Z2, Z3, Z4, Z5 and Z6 are, for example, identical to each other, but the invention is not limited thereto. In other embodiments, the areas of these zones Z0, Z1, Z2, Z3, Z4, Z5 and Z6 are, for example, different from each other, and the areas of these zones may vary depending on the actual requirements. In addition, the zones Z0, Z1, Z2, Z3, Z4, Z5 and Z6 are connectingly adjacent to each other for example, but the invention is not limited thereto. In other embodiments, these zones Z0, Z1, Z2, Z3, Z4, Z5 and Z6 are not connectingly adjacent to each other, or only some of these zones Z0, Z1, Z2, Z3, Z4, Z5 and Z6 are connectingly adjacent to each other. For example, the zones Z0, Z1 and Z2 are connectingly adjacent to each other, and the zones Z3, Z4, Z5 and Z6 are not connectingly adjacent to each other.

The structure of the projector of the embodiment will be described in further detail below.

Please refer to FIGS. 1 and 2. FIG. 2 is a functional block diagram of the projector 1 shown in FIG. 1. As shown in FIG. 2, the projector 1 of the embodiment further includes an adjust assembly 14 and a drive device 15. The adjust assembly 14 is disposed to the projection lens 11, and the adjust assembly 14 rotates with an optical axis of the projection lens 11 as a rotation axis. In the embodiment, the adjust assembly 14 is, for example, a focus length adjustment ring which is disposed around the projection lens 11, but the invention is not limited thereto. When rotating with the optical axis of the projection lens 11 as the rotation axis, the adjust assembly 14 further drives a part of an optical lens group (not shown) located inside the projection lens 11 to move along the extending direction of the optical axis, thereby adjusting the focal length of the projection lens 11. As shown in FIG. 2, the drive device 15 is electrically connected to the processor 13 and the adjust assembly 14. The drive device 15 may feedback the current state to the processor 13. After receiving the image data transmitted from the image capture module 12, the processor 13 further controls the drive device 15 to drive the adjust assembly 14 to rotate according to the image data, thereby adjusting the focal length of the projection lens 11. In the embodiment, the drive device 15 is, for example, a step motor, but the invention is not limited thereto. In the case that the drive device 15 is a step motor, the drive device 15 may feedback the current step number of the step motor to the processor 13.

As shown in FIGS. 1 and 2, the image capture module 12 of the embodiment includes a processing chip 120. The processing chip 120 is electrically connected to the processor 13. After the image capture module 12 captures one image frame M2, the processing chip 120 defines the zones Z0, Z1, Z2, Z3, Z4, Z5 and Z6 on the image frame M2 to discriminate different parts of the image frame M2. The processing chip 120 further analyzes a part of the image frame M2 corresponding to the zones Z0, Z1, Z2, Z3, Z4, Z5 and Z6 to obtain the image data. In the embodiment, the image capture module 12 has the processing chip 120, therefore, when the image capture module 12 captures the image frame M2 covering the entire projection image M1, the processing chip 120 disposed in the image capture module 12 can directly process and analyze the image frame M2 to define the zones Z0, Z1, Z2, Z3, Z4, Z5 and Z6 on the image frame M2, analyze a part of image frame M2 corresponding to these zones Z0, Z1, Z2, Z3, Z4, Z5 and Z6 to obtain the image data, and transmit the image data to the processor 13 of the projector 1 without processing by the processor 13. The processor 13 then automatically adjusts the focal length of the projection lens 11 according to at least two of these zone values selected based on the image data. As a result, the time for adjusting the focal length can be substantially reduced.

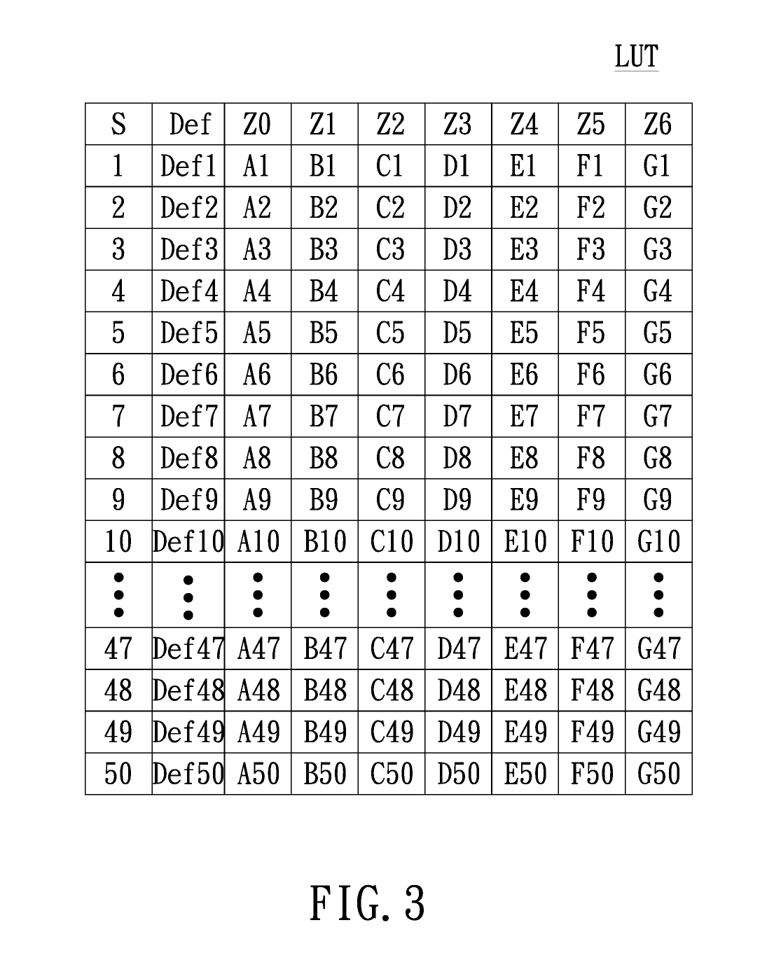

Please refer to FIGS. 1 to 3. FIG. 3 is a diagram showing the content of a lookup table of the projector of the embodiment. The projector 1 of the embodiment shown in FIG. 1 further includes a lookup table LUT. The lookup table LUT is, for example, stored in a database (not shown) of the projector 1, but the invention is not limited thereto. As shown in FIGS. 1 to 3, the lookup table LUT is established according to a distance between the projection lens 11 and the display surface 100. The lookup table LUT of the embodiment includes a plurality of focal length adjustment values S, a plurality pieces of default image data Def corresponding to the respective focal length adjustment values S, and a plurality of zone values corresponding to the respective zones Z0, Z1, Z2, Z3, Z4, Z5 and Z6. In the embodiment, the focal length adjustment value S represents the adjustment value of the drive device 15 for driving the adjust assembly 14 to rotate. Specifically, if the invention uses a step motor as the drive device 15, the focal length adjustment value S in the lookup table LUT represents the step number of the step motor. The focal length adjustment value S of the embodiment is described by being within the numerical range of 1-50 as an example. Each focal length adjustment value S corresponds to one piece of the default image data Def; that is, the step numbers 1-50 of the step motor correspond to the 50 pieces of default image data Def1-Def50 respectively, and each piece of default image data Def corresponds to a group of zone values. In the embodiment, when the projector 1 is turned on and the distance between the projection lens 11 and the display surface 100 is constant, the projector 1 first operates the drive device 15 (a step motor) 50 steps; and the image capture module 12 captures one image frame M2 when the drive device 15 (a step motor) moves one step. Therefore, the image capture module 12 can obtain 50 pieces of default image data Def1-Def50 correspondingly, and then establishes and stores the lookup table LUT in the projector 1, but the invention is not limited thereto. In the embodiment, the zone values are, for example, a plurality of image contrast values corresponding to these zones Z0, Z1, Z2, Z3, Z4, Z5 and Z6 respectively, but the invention is not limited thereto. In other embodiments, the zone values are, for example, a plurality of luminance values corresponding to these zones Z0, Z1, Z2, Z3, Z4, Z5 and Z6 respectively. In the embodiment, each focal length adjustment value S corresponds to a group of zone values, and the zone values corresponding to these zones Z0, Z1, Z2, Z3, Z4, Z5 and Z6 are described by these numerical ranges A1-A50, B1-B50, C1-C50, D1-D50, E1-E50, F1-F50 and G1-G50 respectively. For example, if the value of the focal length adjustment value S is 1, it corresponds to the default image data Def1, and the group of zone values corresponding to the default image data Def1 is A1, B1, C1, D1, E1, F1 and G1; if the value of the focal length adjustment value S is 2, it corresponds to the default image data Def2, and the group of zone values corresponding to the default image data Def2 is A2, B2, C2, D2, E2, F2 and G2; and so on.

As described above, once the lookup table LUT has been established and the projector 1 is in operation, the processor 13, after receiving the image data transmitted from the image capture module 12, selects at least two of these zone values corresponding to these zones Z0, Z1, Z2, Z3, Z4, Z5 and Z6 based on the image data, compares them with the lookup table LUT to determine the closest default image data Def, and obtains the optimum focal length adjustment value according to the closest default image data Def. For example, the processor 13 selects the zone values of the zones Z1 and Z3 and compares them with the lookup table LUT, wherein the zone value (the image contrast value) of the zone Z1 is B8 and the zone value (the picture contrast value) of the zone Z3 is D12 for example. Therefore, according to the lookup table LUT, the focal length adjustment value S corresponding to the image contrast value B8 is 8; the default image data Def corresponding to the picture contrast value B8 is Def8; the focal length adjustment value S corresponding to the picture contrast value D12 is 12; and the default image data Def corresponding to the image contrast value D12 is Def12. Then, the processor 13 computes the focal length adjustment value 8 and the focal length adjustment value 12 to obtain that the optimum focal length adjustment value is 10. According to the optimum focal length adjustment value (e.g., 10), the processor 13 controls the drive device 15 (for example, a step motor) to move 10 steps, the adjust assembly 14 is driven to rotate corresponding to the step number (e.g., 10 steps) of the drive device 15, thereby adjusting the focal length of the projection lens 11 corresponding to the step number of the drive device 15. In another embodiment, for example, the processor 13 selects the zone values of the zones Z2 and Z4 and compares them with the lookup table LUT, wherein the zone value (the picture contrast value) of the zone Z2 is C12 and the zone value (the picture contrast value) of the zone Z4 is E12 for example. Therefore, according to the lookup table LUT, the default image data Def is Def12. Then, the processor 13 obtains that the optimum focal length adjustment value is 12. According to the optimum focal length adjustment value (e.g., 12), the processor 13 controls the drive device 15 (for example, a step motor) to move 12 steps, the adjust assembly 14 is driven to rotate corresponding to the step number (e.g., 12 steps) of the drive device 15, thereby adjusting the focal length of the projection lens 11 corresponding to the step number of the drive device 15.

In particular, the processor 13 selecting at least two of the zone values corresponding to these zones Z0, Z1, Z2, Z3, Z4, Z5 and Z6 based on the image data and comparing them with the lookup table LUT is only one of the embodiments of the invention, and the invention is not limited thereto. In other embodiments, the processor 13 may select at least more than two of the zone values corresponding to these zones Z0, Z1, Z2, Z3, Z4, Z5 and Z6 and compare them with the lookup table LUT to obtain the optimum focus length adjustment value. In addition, when the distance between the projection lens 11 of the projector 1 and the display surface 100 is relatively large and the processor 13 cannot determine the closest default image data Def from the original lookup table LUT, the projector 1 may re-establish the lookup table that corresponds to the relatively-large distance.

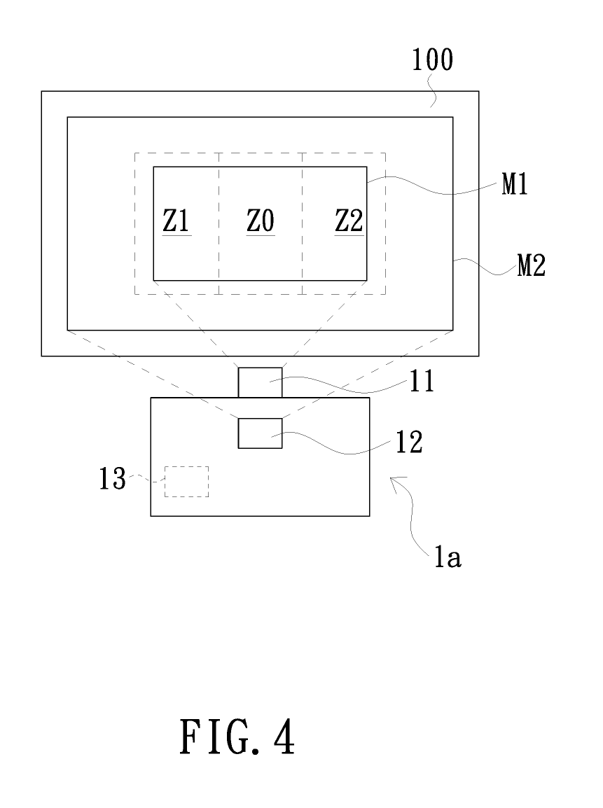

Please refer to FIG. 4, which is a schematic view of a structure and operation of a projector in accordance with another embodiment of the invention. The projector 1a of the embodiment is similar to the projector 1 shown in FIG. 1 except that the number of zones defined by the image capture module 12 on the image frame M2. In the embodiment, the number of zones defined by the image capture module 12 on the image frame M2 is, for example, three, which are the zones Z0, Z1 and Z2. These zones Z0, Z1 and Z2 correspond to different parts of the image frame M2 respectively, and these zones Z0, Z1 and Z2 cover at least part of or the entire projection image M1 and do not cover the entire image frame M2. In the embodiment, among these zones Z0, Z1 and Z2 defined by the image capture module 12 on each image frame M2, the zone Z0 is, for example, located at the center of the projection image M1, and the zones Z1 and Z2 are located on the two opposite sides of the zone Z0 respectively. The areas of these zones Z0, Z1 and Z2 are, for example, identical to each other; these zones Z0, Z1 and Z2 are, for example, connectingly adjacent to each other; but the invention is not limited thereto. In addition, in the embodiment, the projector 1a obtains the image data according to a part of the image frame M2 corresponding to these zones Z0, Z1 and Z2, and adjusts the focal length according to the image data in a manner similar to that described above with reference to FIGS. 2 to 3, the embodiment will not be described in detail.

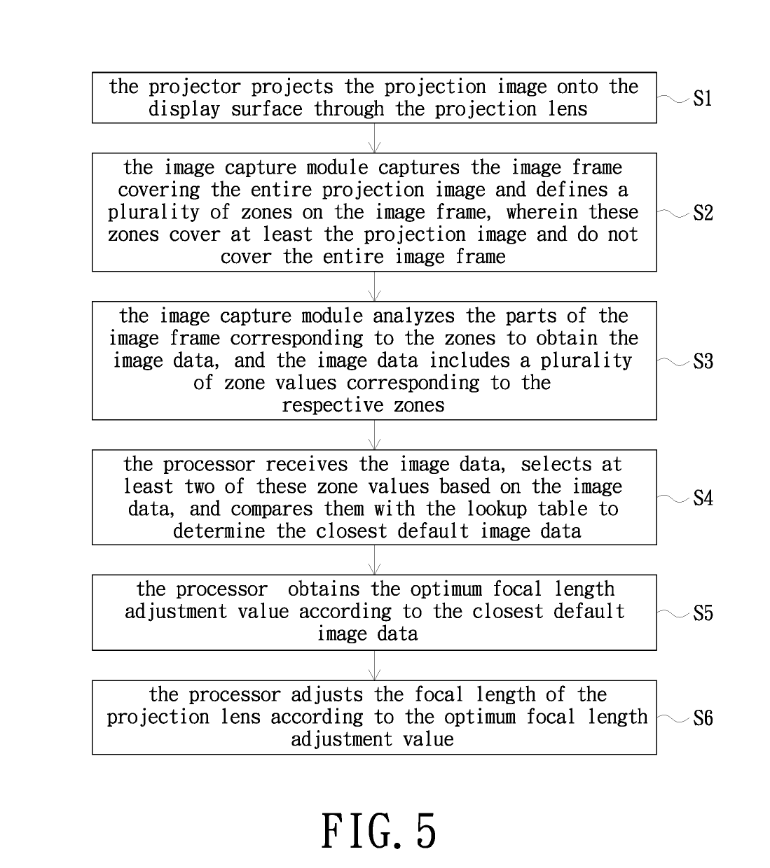

Please refer to FIG. 5, which is a flow chart of a focal length adjusting method in accordance with an embodiment of the invention. The focal length adjusting method of the embodiment is applicable to the projector 1 shown in FIGS. 1 and 2 or the projector 1a shown in FIG. 4. Please refer to FIGS. 1, 2, 3 and 5. As shown, the focal length adjusting method of the embodiment includes the following steps. First, as shown in step S1, the projector 1 projects the projection image M1 onto the display surface 100 through the projection lens 11. Thereafter, as shown in step S2, the image capture module 12 captures the image frame M2 covering the entire projection image M1 and defines the zones Z0, Z1, Z2, Z3, Z4, Z5 and Z6 on the image frame M2. These zones Z0, Z1, Z2, Z3, Z4, Z5 and Z6 correspond to different parts of the image frame M2 respectively, and these zones Z0, Z1, Z2, Z3, Z4, Z5 and Z6 cover at least part of or the entire projection image M1 and do not cover the entire image frame M2. Thereafter, as shown in step S3, the image capture module 12 analyzes a part of the image frame M2 corresponding to the zones Z0, Z1, Z2, Z3, Z4, Z5 and Z6 to obtain the image data, and the image data includes a plurality of zone values corresponding to the respective zones Z0, Z1, Z2, Z3, Z4, Z5 and Z6. Thereafter, as shown in step S4, the processor 13 receives the image data, selects at least two of these zone values based on the image data, and compares them with the lookup table LUT to determine the closest default image data Def. Thereafter, as shown in step S5, the processor 13 obtains the optimum focal length adjustment value according to the closest default image data Def. Thereafter, as shown in step S6, the processor 13 adjusts the focal length of the projection lens 11 according to the optimum focal length adjustment value. In step S3, the image capture module 12 is disposed with the processing chip 120; therefore, after the image capture module 12 captures the image frame M2, the processing chip 120 can directly define the zones Z0, Z1, Z2, Z3, Z4, Z5 and Z6 on the image frame M2, analyze a part of the image frame M2 corresponding to these zones Z0, Z1, Z2, Z3, Z4, Z5 and Z6 to obtain the image data, and transmit the image data to the processor 13. In step 4, the lookup table LUT is, for example, stored in the projector 1 and includes a plurality of focal length adjustment values S (the numerical range 1-50, as shown in FIG. 3), a plurality pieces of default image data Def corresponding to the respective focal length adjustment values S (the numerical range Def1-Def50, as shown in FIG. 3), and a plurality of zone values corresponding to the respective zones Z0, Z1, Z2, Z3, Z4, Z5 and Z6 (the numerical ranges A1-A50, B1-B50, C1-C50, D1-D50, E1-E50, F1-F50 and G1-G50, as shown in FIG. 3).

In another embodiment, after the user adjusts the size of the projection image M1 on the display surface 100, the projector 1 can automatically adjust the focal length of the projection lens 11 by the above-described focal length adjusting method. In other embodiments, the image capture module 12 defines a plurality of zones on the image frame M2 and these zones cover the entire projection image M1. The processor 13 selects all these zone values based on the image data from the image capture module 12 and calculates the information of the edge of the projection image M1, thereby performing a keystone correction for the projection image M1.

In summary, the projector and the focal length adjusting method in accordance with the embodiments of the invention define a plurality of zones respectively corresponding to different parts of the image frame which covers the entire projection image and is captured by the image capture module, obtain the image data including a plurality of zone values respectively corresponding to the zones, and adjust the focal length of the projection lens according to at least two of these zone values selected based on the image data by the processor. Therefore, compared with the known technique in that the focal length adjustment is performed based on the data obtained by analyzing the entire image frame, the projector and the focal length adjusting method in accordance with the embodiments of the invention can perform the focal length adjustment more quickly and efficiently.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A projector, comprising:
a projection lens adapted to project a projection image onto a display surface;
an image capture module disposed on one side of the projection lens and adapted to capture an image frame covering the projection image and define a plurality of zones on the image frame, wherein the plurality of zones respectively correspond to different parts of the image frame, the plurality of zones cover at least the projection image and do not cover the entire image frame, the image capture module further analyzes the parts of the image frame respectively corresponding to the plurality of zones to obtain image data, and the image data comprises a plurality of zone values respectively corresponding to the plurality of zones; and
the processor electrically connected to the image capture module, wherein the processor receives the image data and adjusts a focal length of the projection lens according to at least two of the plurality of zone values selected based on the image data.

2. The projector according to claim 1, further comprising:
an adjust assembly disposed to the projection lens, wherein the adjust assembly rotates with an optical axis of the projection lens as a rotation axis, thereby adjusting the focal length of the projection lens; and
a drive device electrically connected between the processor and the adjust assembly, wherein the processor controls the drive device to drive the adjust assembly to rotate according to the image data.

3. The projector according to claim 1, wherein the image capture module comprises a processing chip electrically connected to the processor, the processing chip defines the plurality of zones to discriminate the different parts of the image frame and analyzes the parts of the image frame corresponding to the plurality of zones to obtain the image data.

4. The projector according to claim 1, further comprising a lookup table including a plurality of focus length adjustment values, wherein the processor compares at least two of the plurality of zone values with the lookup table to determine an optimum focal length adjustment value from the plurality of focal length adjustment values in the lookup table, and adjust the focal length of the projection lens according to the optimum focal length adjustment value.

5. The projector according to claim 4, wherein the lookup table comprises a plurality pieces of default image data, the plurality pieces of default image data respectively correspond to the plurality of different focal length adjustment values, and the processor compares at least two of the plurality of zone values with the lookup table to determine the optimum focal length adjustment value from the plurality of focal length adjustment values in the lookup table.

6. The projector according to claim 1, wherein the plurality of zones defined by the image capture module comprises a first zone located at a center position of the projection image and a plurality of second zones surrounding the first zone.

7. The projector according to claim 1, wherein the plurality of zones defined by the image capture module comprises a first zone located at a center position of the projection image and at least one second zone located on one side of the first zone.

8. The projector according to claim 1, wherein the plurality of zones are connectingly adjacent to each other, the plurality of zones are not connectingly adjacent to each other, or some of the plurality of zones are connectingly adjacent to each other.

9. The projector according to claim 4, wherein the plurality of zone values are a plurality of image contrast values or a plurality of luminance values.

10. A focal length adjusting method for a projector, the projector comprising a projection lens, an image capturing module and a processor, the focal length adjusting method comprising:
configuring the projector to project a projection image onto a display surface through a projection lens;
configuring the image capture module to capture an image frame covering the projection image and define a plurality of zones on the image frame, wherein the plurality of zones respectively correspond to different parts of the image frame, and the plurality of zones cover at least the projection image and do not cover the entire image frame;
configuring the image capture module to analyze the parts of the image frame respectively corresponding to the plurality of zones to obtain image data, wherein the image data comprises a plurality of zone values respectively corresponding to the plurality of zones;
configuring the processor to receive the image data and adjust a focal length of the projection lens according to at least two of the plurality of zone values selected based on the image data.

11. The focal length adjusting method according to claim 10, wherein the projector further comprises a lookup table including a plurality of focus length adjustment values, the processor compares at least two of the plurality of zone values with the lookup table to determine an optimum focal length adjustment value from the plurality of focal length adjustment values in the lookup table, and adjust the focal length of the projection lens according to the optimum focal length adjustment value.

12. The focal length adjusting method according to claim 11, wherein the lookup table comprises a plurality pieces of default image data, the plurality pieces of default image data respectively correspond to the plurality of different focal length adjustment values, and the processor compares at least two of the plurality of zone values with the lookup table to determine the optimum focal length adjustment value from the plurality of focal length adjustment values in the lookup table.

13. The focal length adjusting method according to claim 10, wherein the plurality of zones defined by the image capture module comprises a first zone located at a center position of the projection image and a plurality of second zones surrounding the first zone.

14. The focal length adjusting method according to claim 10, wherein the plurality of zones defined by the image capture module comprises a first zone located at a center position of the projection image and at least one second zone located on one side of the first zone.
